(19) United States
(12) Patent Application Publication
(10) Pub. No.: US 2024/0363118 A1
(43) Pub. Date: Oct. 31, 2024

(54) LIGHTING AND ANIMATION SYSTEM FOR A MUSICAL INSTRUMENT, ANIMATION PATTERNS, AND IMPLEMENTS FOR MOUNTING LIGHTING COMPONENTS TO MUSICAL INSTRUMENTS

(71) Applicant: David KASLE, Mountain View, CA (US)

(72) Inventor: David KASLE, Mountain View, CA (US)

(21) Appl. No.: 18/235,274

(22) Filed: Aug. 17, 2023

Related U.S. Application Data
(60) Provisional application No. 63/462,168, filed on Apr. 26, 2023.

(51) Int. Cl. G10L 15/28; G10D 13/02; G10D 13/10; G10L 21/06; H05B 45/10; H05B 45/20; H05B 47/12; H05B 47/16

(52) U.S. Cl. CPC G10L 15/28; G10D 13/02; G10D 13/10; G10L 21/06; H05B 45/10; H05B 45/20; H05B 47/12; H05B 47/16

(57) ABSTRACT

Embodiments of the present invention provide a musical instrument with integrated LED lighting capable of rendering animation sequences. The light produced may take the form of an animation or sequence of light/color that resembles a moving object or moving pattern, such as rainfall, waves, streams, text, etc. The amount of light or the amount of color in the object or pattern and/or the speed of movement of the object or pattern dynamically changes in accordance with the sound level of the sound producing instrument. The lighting system can be tuned to control various aspects of the light and/or animation generated by the LEDs using an external touch-based device to adjust a sound level sensitivity or threshold, a speed of the animation, or a brightness setting of the lighting system. The LEDs can be integrated in a panel that is secured to the musical instrument using novel mounting implements described herein.

### CROSS-REFERENCE TO RELATED APPLICATIONS:

This application claims benefit of and priority to U.S. Provisional Patent Application No. 63/462,168 filed Apr. 26, 2023, and having the same title as the instant application, the content of which is hereby incorporated by reference in its entirety for all purposes as if set forth fully below.

### FIELD

Embodiments of the present invention generally relate to the field of dynamic lighting and animation systems. More specifically, embodiments of the present invention relate to methods and apparatus for controllably generating dynamic lighting and animation to accompany a musical instrument for entertainment.

### BACKGROUND

There is growing need in the field of lighting systems to provide a lighting experience based on input, such as sound generated by a musical instrument, to augment the music played by the instrument, and to enhance audience enjoyment thereof and entertainment in general. There are a growing number of venues that combine the playing of musical instruments, by artists, with lighting devices.

Conventional lighting systems that are used with musical instruments generally rely on pre-determined or pre-recorded lighting sequences or animations, and cannot adequately generate new, dynamic lighting sequences or animations in real-time, especially based on sound input of a musical instrument. Furthermore, current musical event lighting systems cannot easily be adjusted to adjust or modify the lighting sequences or animations because the lighting sequences or animations are pre-defined, e.g., “canned,” with a few exceptions.

Furthermore, most existing event lighting systems are housed in separate enclosures and require complicated wiring to connect the lighting components together. What is needed is a flexible, dynamic lighting system capable of generating dynamic and adjustable lighting sequences or animations based on sound input. Moreover, what is needed is a cost-effective mounting solution for lighting systems outside or within a musical instrument that does not obscure the light within the musical instrument, and that can withstand the vibration and percussion thereof.

### SUMMARY:

Accordingly, embodiments of the present invention provide an apparatus for producing dynamic lighting for use in conjunction with a musical instrument. The apparatus comprises a housing, a microphone operable to detect real-time sound levels produced by the musical instrument, an LED interface and panel for controllably emitting light using a plurality of LEDs wherein each LED is discretely activated, a mounting implement operable to secure the LED panel to the housing, and a microcontroller operable to send control signals to the LED interface to cause the plurality of LEDs to emit light corresponding to lighting sequences. The lighting sequences are dynamically adjusted responsive to the real-time sound levels produced by the musical instrument exceeding a predetermined threshold.

According to some embodiments, the plurality of LEDs is disposed within the musical instrument, and the surface is substantially transparent.

According to some embodiments, the plurality of LEDs is disposed on a surface of the musical instrument.

According to some embodiments, the plurality of LEDs is secured to the surface of the musical instrument using a plurality of standoffs.

According to some embodiments, the apparatus includes a touch screen or other graphical user interface input device communicatively coupled to the microcontroller and operable to adjust a brightness level of the plurality of LEDs according to an input received by the touch screen or other graphical user interface input device.

According to some embodiments, the apparatus includes a touch screen or other graphical user interface input device communicatively coupled to the microcontroller and operable to adjust an animation speed the lighting sequences according to an input received by the touch screen or other graphical user interface input device.

According to some embodiments, the apparatus includes a touch screen or other graphical user interface input device communicatively coupled to the microcontroller and operable to adjust the threshold according to an input received by the touch screen or other graphical user interface input device.

According to some embodiments, the apparatus includes a touch screen or other graphical user interface input device communicatively coupled to the microcontroller and operable to receive red, green, and blue color values according to touch an input received by the touch screen or other graphical user interface input device, and store the red, green, and blue color values as a stored color, and the microcontroller is operable to cause the plurality of LEDs to emit light corresponding to the stored color.

According to a different embodiment, a method of producing LED lighting responsive to sound produced by a musical instrument is disclosed. The method includes receiving control signals from an external touch screen or other graphical user interface device operable to render a graphical user interface, sending the control signals to an LED interface to cause the LED interface to illuminate a plurality of LEDs, disposed in an array, using an LED animation sequence corresponding to the control signals, measuring a sound level produced by a musical instrument in real-time using a microphone, determining that the sound level of the musical instrument is above a sound level threshold, and generating updated control signals for the LED interface. The updated control signals dynamically adjust the LED animation sequence responsive to determining that the sound level is above the sound level threshold, and the LED interface controls the plurality of LEDs to produce the LED animation sequence in accordance with the sound level produced by the musical instrument.

According to some embodiments, the LED animation sequence includes illuminating LEDs of the plurality of LEDs in a rainfall pattern.

According to some embodiments, the updated control signals adjust the LED animation sequence by increasing an animation speed of the LED animation sequence.

According to some embodiments, receiving control signals from an external device includes receiving red, green, and blue color values from a color mixer of the graphical user interface.

According to some embodiments, receiving control signals from an external device includes receiving a brightness level from a slider of the graphical user interface.

According to some embodiments, receiving control signals from an external device includes receiving a threshold level from a slider of the graphical user interface.

According to some embodiments, receiving control signals from an external device includes receiving an animation speed of the LED animation sequence from a slider of the graphical user interface.

According to some embodiments, the method further includes reviving a new animation sequence from the external device.

According to a different embodiment, a musical instrument for generating animated LED lighting is disclosed. The musical instrument includes a housing, an LED panel for emitting light using a plurality of LEDs, a mounting implement coupled to the housing and operable to secure the LED panel to the housing. The mounting implement includes a base fixed to the housing operable to support the LED panel, and a fastener operable to tighten the base against the LED panel.

According to some embodiments, the housing is made from a substantially

transparent material, the musical instrument further includes a cavity that is visible from outside of the musical instrument, and the LED panel is disposed within the cavity and is operable to illuminate the cavity.

According to some embodiments, the LED panel is disposed on an outer surface of the housing.

### BRIEF DESCRIPTION OF THE DRAWINGS:

The accompanying drawings, which are incorporated in and form a part of this specification, illustrate embodiments of the invention and, together with the description, serve to explain the principles of the invention:

FIG. 1 is a diagram of an exemplary graphical user interface (GUI) for controlling an LED lighting and animation system for use with a musical instrument is depicted according to embodiments of the present invention.

FIG. 2 is a diagram of an exemplary on-screen graphical user interface for controlling an LED lighting and animation system for use with a musical instrument according to embodiments of the present invention.

FIG. 3 is a diagram of an exemplary on-screen graphical user interface for controlling an LED lighting and animation system including a color mixer for use with a musical instrument according to embodiments of the present invention.

FIG. 4 is a diagram of an exemplary on-screen graphical user interface for controlling an LED lighting and animation system including a color mixer that can store selected colors for use with a musical instrument according to embodiments of the present invention.

FIG. 5 is a diagram of an exemplary falling rain animation created by selectively driving LED lights according to embodiments of the present invention.

FIG. 6 is a diagram of an exemplary rising rain animation created by selectively driving LED lights according to embodiments of the present invention.

FIG. 7 is a diagram of an exemplary rising and falling rain animation created by selectively driving LED lights according to embodiments of the present invention.

FIG. 8 is a diagram of an exemplary diagonal wave animation created by selectively driving LED lights according to embodiments of the present invention.

FIG. 9 is a diagram of an exemplary vertical wave animation created by selectively driving LED lights according to embodiments of the present invention.

FIG. 10 is a diagram of an exemplary random horizontal streams animation created by selectively driving LED lights according to embodiments of the present invention.

FIG. 11 is a diagram of an exemplary twinkling stars animation, where one star is getting brighter as the frames progress, and another star is getting dimmer as the frames progress, created by selectively driving LED lights according to embodiments of the present invention.

FIG. 12 is a diagram of an exemplary spiral inward animation created by selectively driving LED lights according to embodiments of the present invention.

FIG. 13 is a diagram of an exemplary spiral outward animation created by selectively driving LED lights according to embodiments of the present invention.

FIG. 14 is a diagram of an exemplary fireworks animation created by selectively driving LED lights according to embodiments of the present invention.

FIG. 15 is a diagram of an exemplary expanding/contracting square animation created by selectively driving LED lights according to embodiments of the present invention.

FIG. 16 is a diagram of an exemplary sound meter animation that grows over time (as sound is detected) created by selectively driving LED lights according to embodiments of the present invention.

FIG. 17 is a diagram of an exemplary musical instrument including an LED lighting system secured to musical instrument using one or more standoffs according to embodiments of the present invention.

FIG. 18 is a diagram of an exemplary computer-controlled lighting control system for generating animation sequences displayed on an LED lighting system of a musical instrument according to embodiments of the present invention.

FIG. 19 is a diagram of an exemplary computer-controlled lighting control system for generating animation sequences displayed on an LED lighting system of a musical instrument using a microphone of a computer system according to embodiments of the present invention.

### DETAILED DESCRIPTION:

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Portions of the detailed description that follows are presented and discussed in terms of a method. Although steps and sequencing thereof are disclosed in a figure herein the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying,” “updating,” “determining,” “selecting,” “animating,” “displaying,” “lighting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Lighting and Animation System for Musical Instrument

Methods and apparatus for producing dynamic lighting and lighting animation for a musical instrument (e.g., a drum, piano, guitar, etc.) are disclosed herein. According to some embodiments, light is produced using color LEDs driven by electronics that are responsive to sound input such that the amount of light produced by the LEDs, or the sequence and/or color produced by the LEDs, is dynamic and particularly proportional to or otherwise associated with the real-time sound level detected by a microphone, pressure sensor, or the like. The sound can originate from any sound producing instrument. In the preferred embodiment, the sound producing instrument is a musical instrument, and the LEDs respond in real-time to the sound to augment the musical entertainment. While some embodiments of the present invention use LEDs as a light source, any suitable lighting source can be used, such as organic LEDs (OLEDs) or color liquid crystal displays (LCDs), or the like.

The light produced may take the form of an animation or sequence of light/color that resembles a moving object or moving pattern, such as rainfall or a spiral, or a moving ribbon of colors, or a moving star pattern, for example. The amount of light or the amount of color in the object or pattern created by the dynamic LED lights and/or the speed of movement of the object or pattern dynamically changes in accordance with a real-time sound level of the sound producing instrument. The result is a light show that dynamically changes in synchronization with the sound in real-time to augment the entertainment experience of the viewer/listener. The lighting system can be tuned to control various aspects of the light and/or animation generated by the LEDs, for example, using an external touch-based or other graphical user interface device to adjust a sound level sensitivity or threshold, a speed of the animation, or a brightness setting of the lighting system.

The dynamic lighting and/or dynamic animation system of the present invention can be used in combination with the playing of a musical instrument to enhance the enjoyment and entertainment of the musical instrument. The system can be placed inside the instrument, placed onto the instrument or placed adjacent to the instrument, for instance, as long as the lighting sources can be viewed by an audience while the instrument is being played.

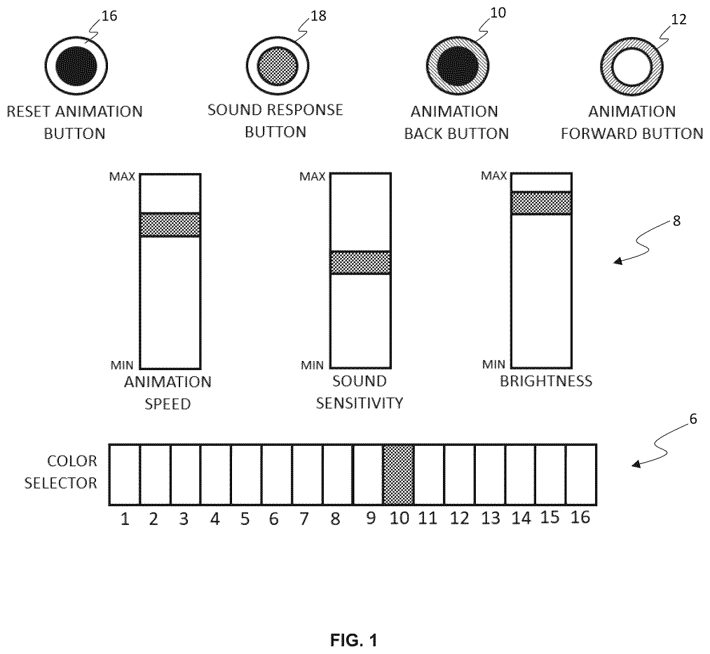

With regard to FIG. 1, an exemplary graphical user interface (GUI) for controlling an LED lighting and animation system for use with a musical instrument is depicted according to embodiments of the present invention. The user interface can be displayed on any suitable display of a smart device, such as a touchscreen control panel, tablet, smartphone, and the like. The interface includes touch-sensitive inputs, e.g., GUI elements, for adjusting/selecting the speed, sensitivity and brightness of the LED lighting system, and sends corresponding control signals to a processor or controller of the LED lighting system to produce the desired effect.

According to some embodiments, control signals are transmitted by an external device, such as a laptop, tablet, or smartphone using a wired or wireless connection, such as Bluetooth, Wi-Fi, etc. The external device can execute a specific application that provides the control signals according to input received from a graphical user interface (e.g., the exemplary interfaces depicted in FIGS. 1-4 herein) via a touchscreen, keyboard, mouse, trackpad, or the like. Moreover, embodiments can be configured in a master-slave arrangement, where multiple LED lighting systems (e.g., corresponding to the same musical instrument or different musical instruments) are controlled by a single “master” device. In other words, any LED lighting commands sent to the master device, using one of the graphical user interfaces depicted herein, for example, are transmitted to the “slave” devices to generate the same LED animation sequence, and/or the same lighting configuration, such as speed, brightness, sound threshold, etc. According to some embodiments, a graphical user interface is provided that includes a list of connected LED lighting systems, and different LED lighting systems can be selected to operate in a slave mode under the control of a corresponding master device.

In the example of FIG. 1, the touch-sensitive inputs are on-screen slidable control knobs (“sliders”) 8 that can be used to select from a range of values. Different pre-programmed animations can be selected using the forward button 12 and back button 10 of the graphical user interface, and different preset color combinations can be selected using the row of color selector buttons 6. The reset animation button 16 turns off all of the LEDs of the LED lighting system. The sound response button 18 can be activated to toggle between predefined automatic animations that can run continuously without responding to sound, and animations that are generated in real-time in response to sounds detected by a microphone, pressure sensor, or the like.

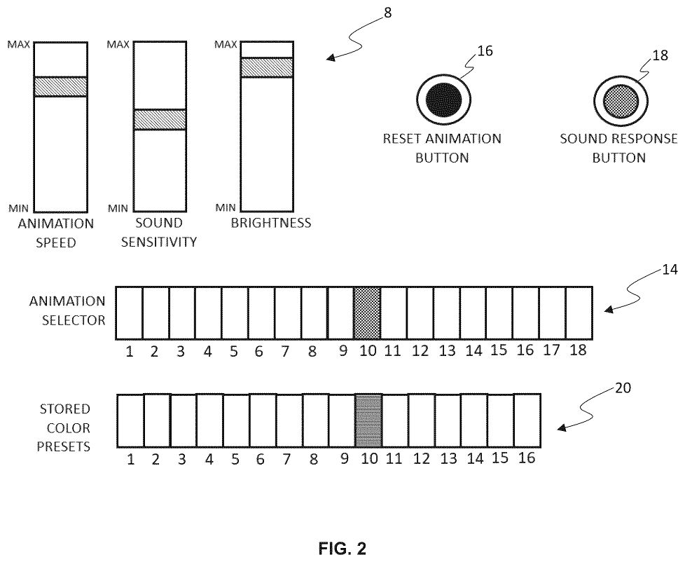

FIG. 2 depicts an exemplary on-screen graphical user interface for controlling an LED lighting and animation system for use with a musical instrument according to embodiments of the present invention. The example depicted in FIG. 2 is similar to the embodiment of FIG. 1, with the forward button 12 and back button 10 replaced by a row of pre-programmed animation selector buttons 14, which can reduce the amount of time required to select the desired animation.

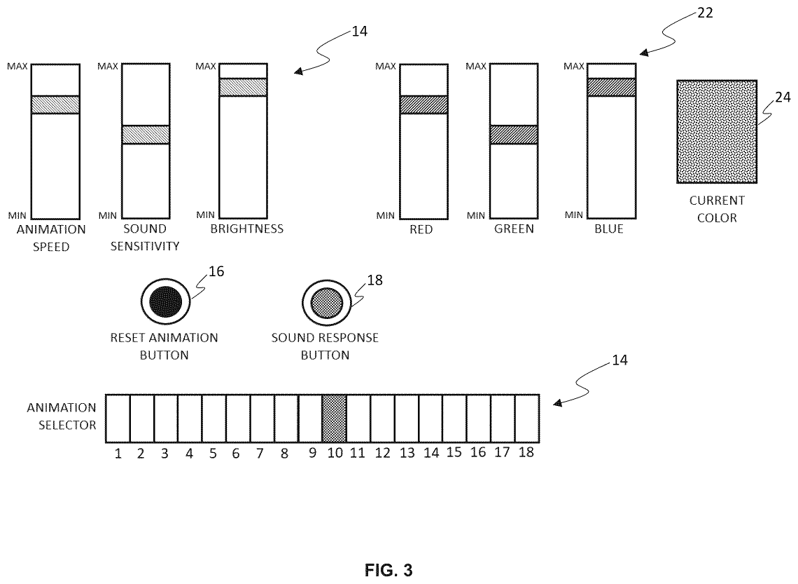

FIG. 3 depicts an exemplary on-screen graphical user interface for controlling an LED lighting and animation system including a color mixer 22 for use with a musical instrument according to embodiments of the present invention. The graphical user interface depicted in FIG. 3 includes different preset animations that can be selected using pre-programmed animation selector buttons 14. The desired animation color can be selected by combining different values of red, green and blue using the corresponding sliders of the color mixer 22. The current color box 24 shows the user the result of the selected combination of red, green and blue. The animation produced by the LED lighting system is generated using the color selected using the color mixer 22 and the animation selected using animation selector 14.

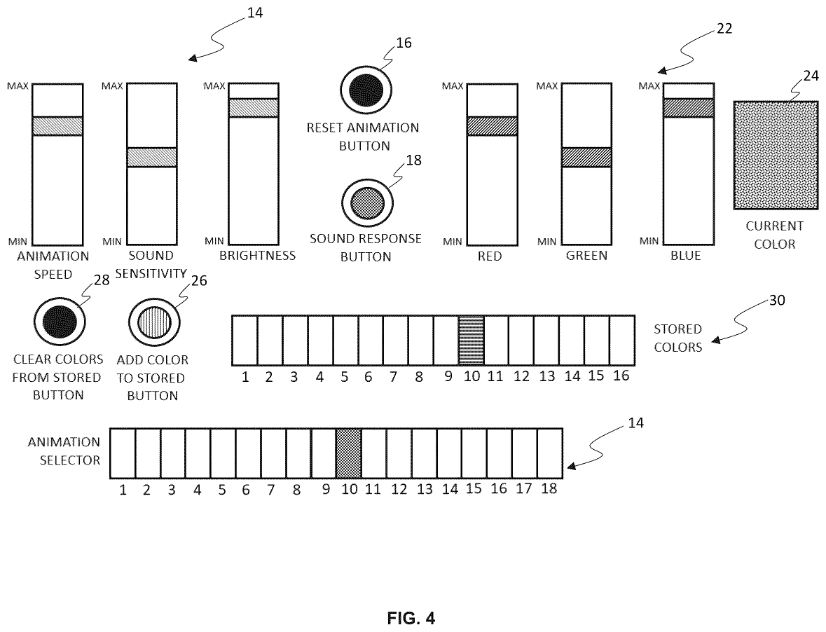

FIG. 4 depicts an exemplary on-screen graphical user interface for controlling an LED lighting and animation system including a color mixer that can store selected colors for use with a musical instrument according to embodiments of the present invention. The exemplary graphical user interface depicted in FIG. 4 can select a color made from any combination of red, green and blue using a color mixer 22, and the selected color can be stored and added to the row of stored color buttons 30. For example, to store blue and yellow colors for generating animation sequences using a combination of selected colors (e.g., to make some parts of any of the animations blue and some parts yellow), the blue slider is set to maximum, and the red slider and green slider are set to minimum to produce blue. One of the buttons of the stored color row of buttons 30 is selected to store the color blue, and the “add color to stored” button 26 is selected to store the color. Next, the blue slider to is set to minimum and the red slider and green slider are set to maximum to produce yellow. The same button in the stored color row of buttons 30 that was selected to store blue is selected again to also store yellow, in addition to blue. The “add color to stored” button 26 is selected again to store yellow together with blue, which was already stored in the selected stored color button.

To execute an animation (e.g., a rain animation) using the stored color values, the button from the stored color row of buttons where blue and yellow are stored is selected, which results in an animation in a rainfall pattern, where some of the raindrops are blue, and some of the raindrops are yellow. The “clear colors from stored” 28 button can be selected to erase colors from a selected stored color button to allow for re-programmed with a new combination of selected colors.

### Animation Patterns for Musical Instrument

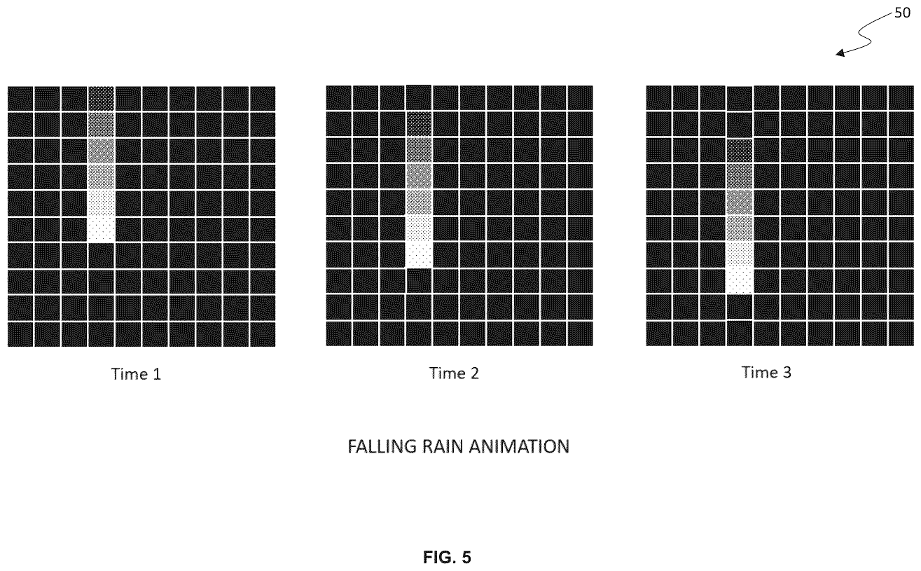

FIGS. 5-16 depict frames of time slices of exemplary LED animation patterns that can be produced according to embodiments of the present invention. The frames can be generated using a selected color using a color mixer, a predefined color, or a previously stored color, according to embodiments. Moreover, as described above, the animation can be generated responsive to sound produced by the musical instrument, or any sound detected by a microphone, pressure sensor, or the like, and can be adjusted to animate at different speeds (e.g., more or fewer frames of animation per second), brightness, and sound sensitivity levels.

FIG. 5 depicts still frames over time of an exemplary falling rain animation 50 created by selectively driving LED lights according to embodiments of the present invention. The animation advances in accordance with the detected sound.

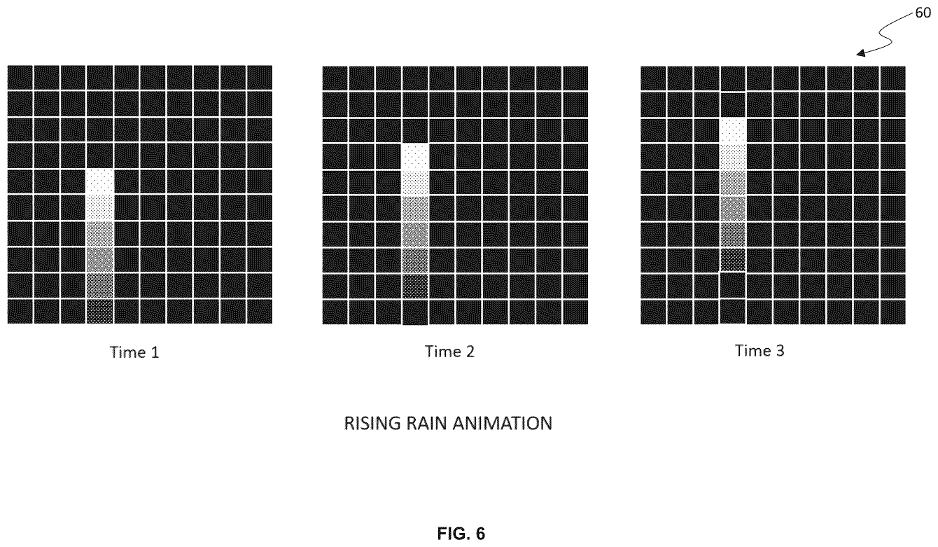

FIG. 6 depicts still frames over time of an exemplary rising rain animation 60 created by selectively driving LED lights according to embodiments of the present invention. The animation advances in accordance with the detected sound.

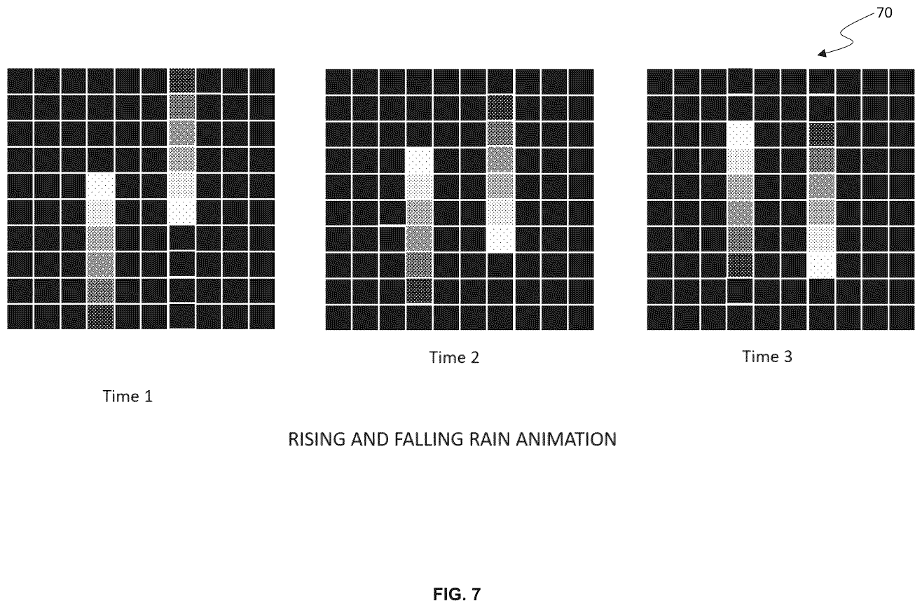

FIG. 7 depicts still frames over time of an exemplary rising and falling rain animation 70 created by selectively driving LED lights according to embodiments of the present invention. The animation advances in accordance with the detected sound.

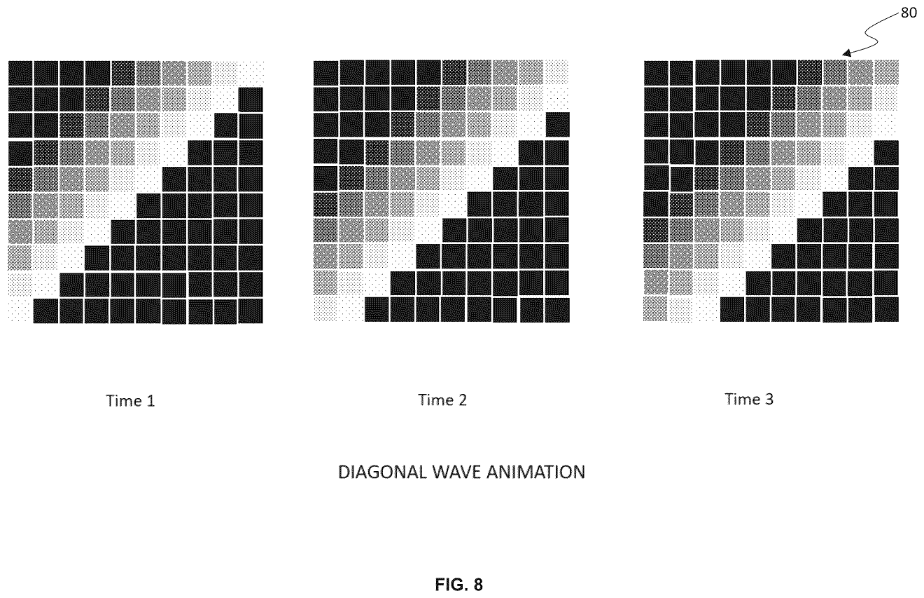

FIG. 8 depicts still frames over time of an exemplary diagonal wave animation 80 created by selectively driving LED lights according to embodiments of the present invention. The animation advances in accordance with the detected sound.

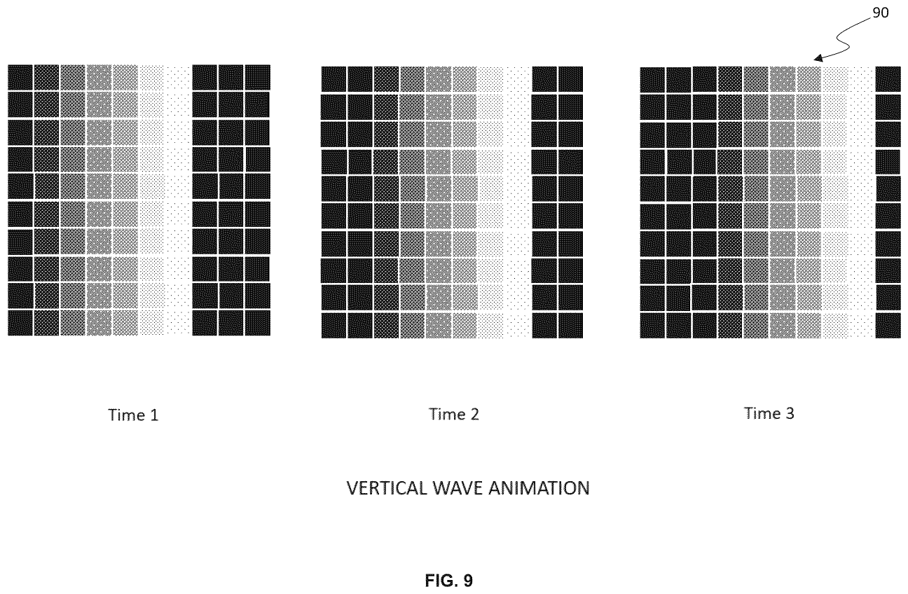

FIG. 9 depicts still frames over time of an exemplary vertical wave animation 90 created by selectively driving LED lights according to embodiments of the present invention. The animation advances in accordance with the detected sound.

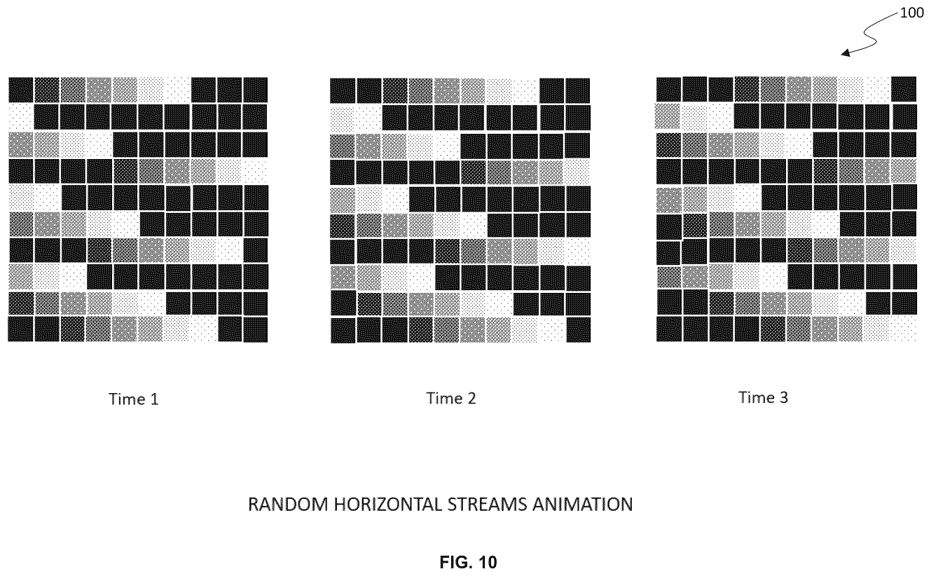

FIG. 10 depicts still frames over time of an exemplary random horizontal streams animation 100 created by selectively driving LED lights according to embodiments of the present invention. The animation advances in accordance with the detected sound.

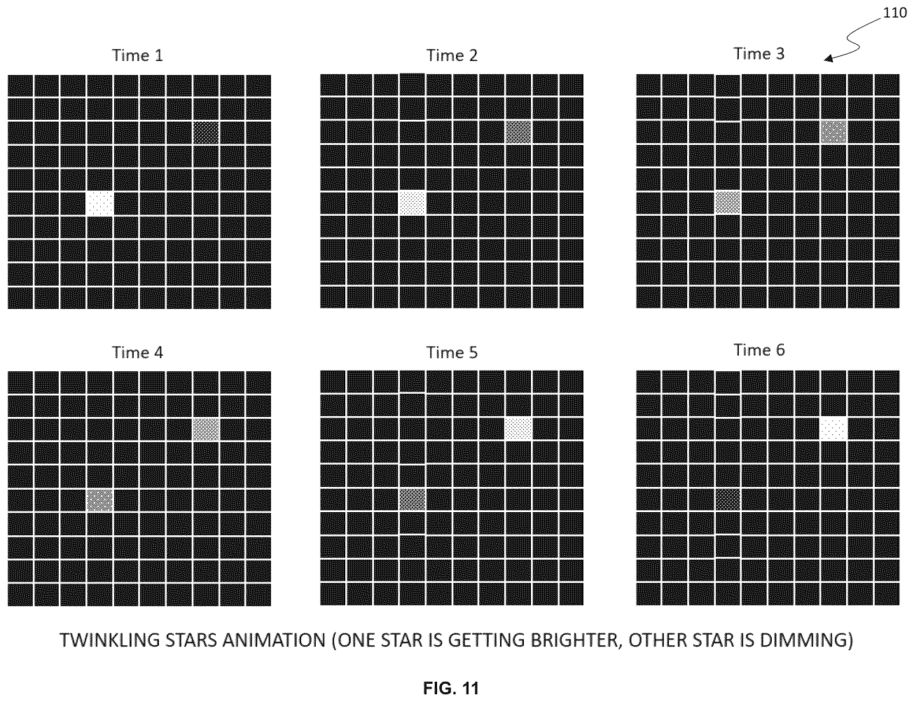

FIG. 11 depicts still frames over time of an exemplary twinkling stars animation 110, where one star is getting brighter as the frames progress, and another star is getting dimmer as the frames progress, created by selectively driving LED lights according to embodiments of the present invention. The animation advances in accordance with the detected sound.

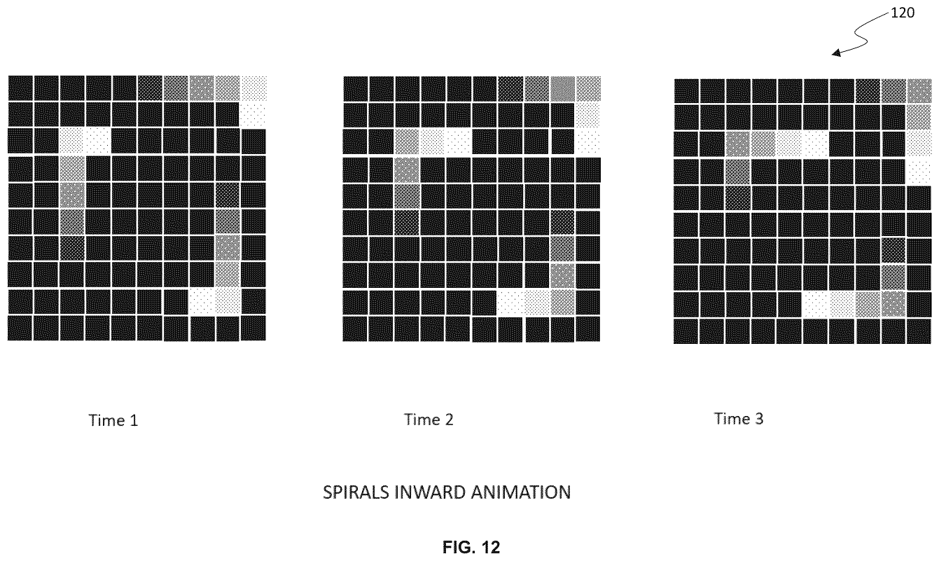

FIG. 12 depicts still frames over time of an exemplary spiral inward animation 120 created by selectively driving LED lights according to embodiments of the present invention. The animation advances in accordance with the detected sound.

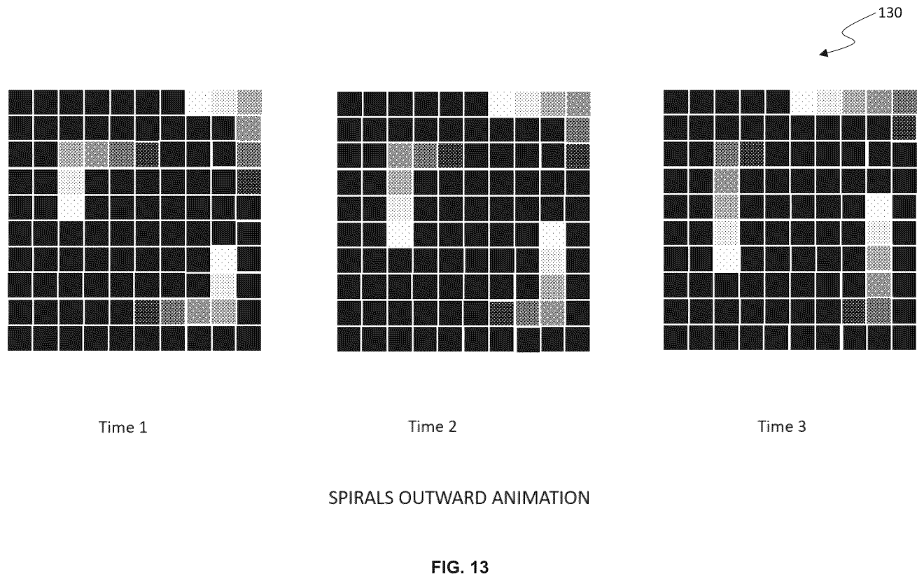

FIG. 13 depicts still frames over time of an exemplary spiral outward animation 130 created by selectively driving LED lights according to embodiments of the present invention. The animation advances in accordance with the detected sound.

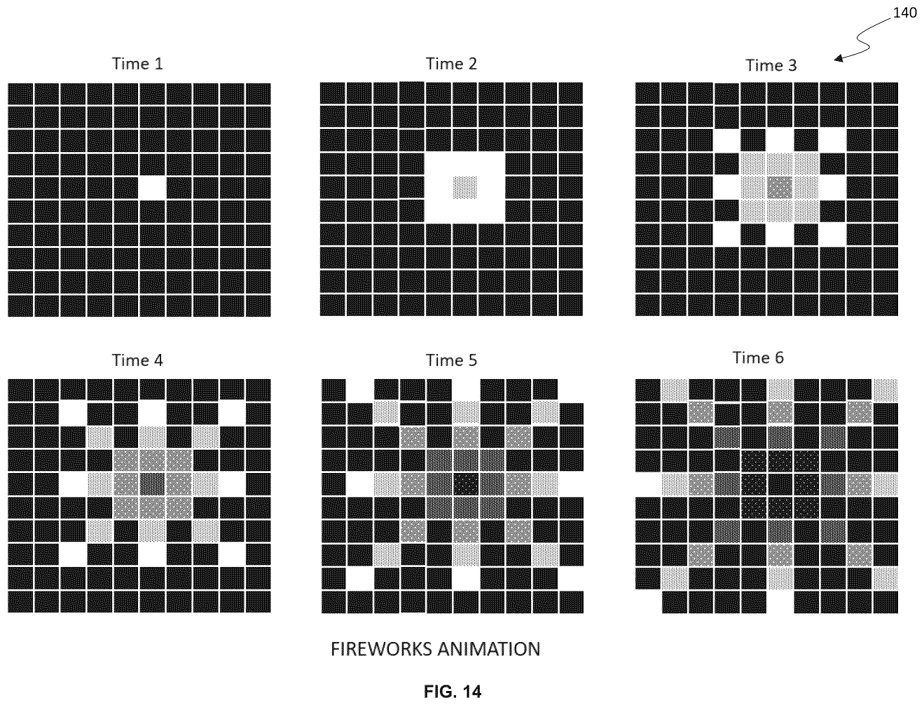

FIG. 14 depicts still frames over time of an exemplary fireworks animation 140 created by selectively driving LED lights according to embodiments of the present invention. The animation advances in accordance with the detected sound.

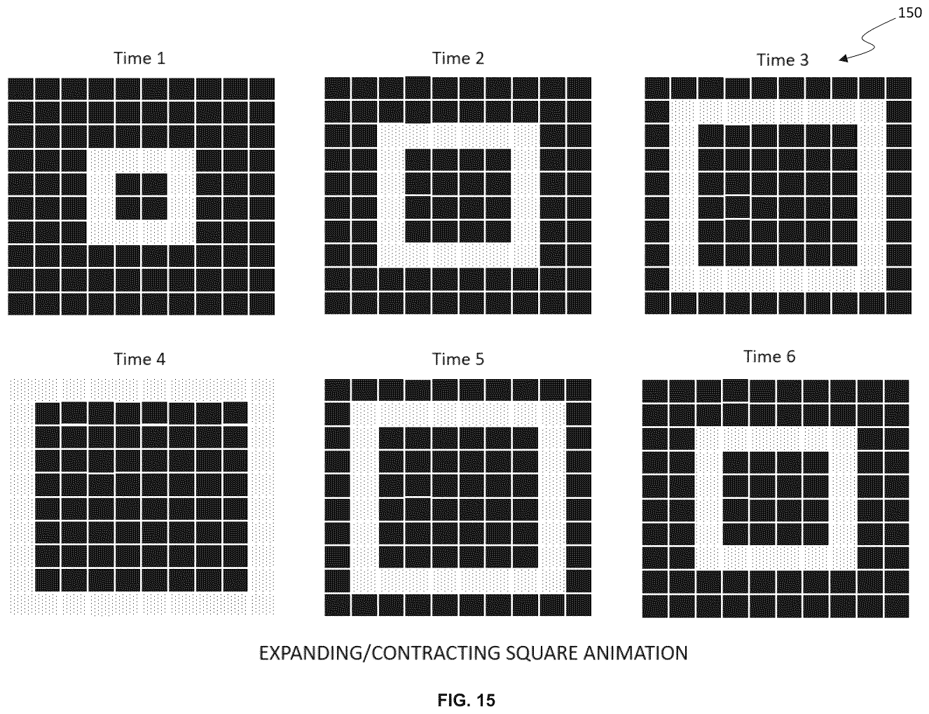

FIG. 15 depicts still frames over time of an exemplary expanding/contracting square animation 150 created by selectively driving LED lights according to embodiments of the present invention. The animation advances in accordance with the detected sound.

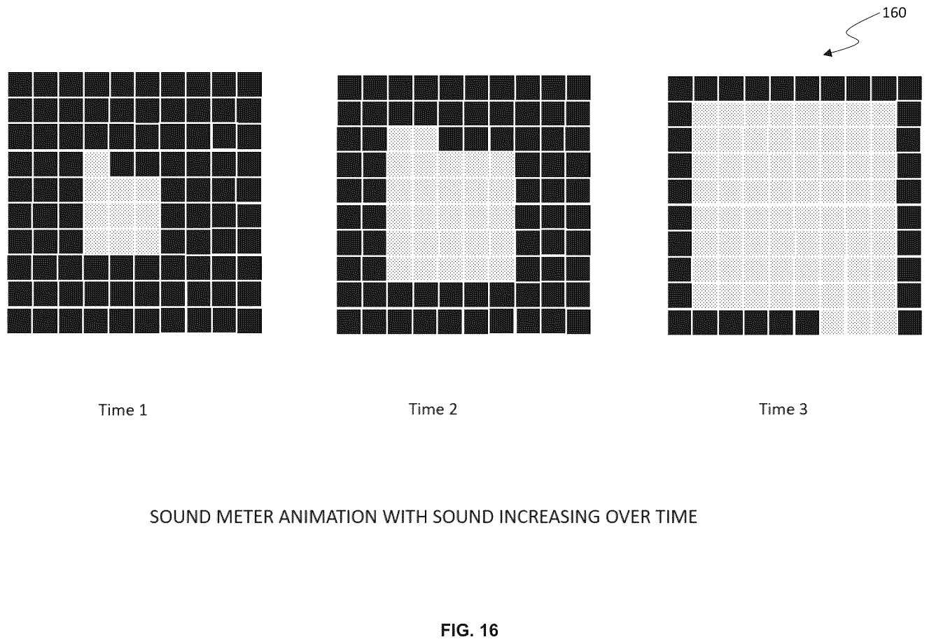

FIG. 16 depicts still frames over time of an exemplary sound meter animation 160 that grows over time (as sound is detected) created by selectively driving LED lights according to embodiments of the present invention. The animation advances in accordance with the detected sound.

Embodiments of the present invention can also produce other animation patterns, such as lighting bolt animations, police siren animations, scrolling text animations, and other animation patterns that can be defined using a remote computer system in communication with the LED lighting system. Some embodiments can communicate with a remote computer system to download new configurations for the LED lighting system (e.g., new animation patterns, software updates, etc.). According to some embodiments, the remote computer system can be used to enter a string of text that is transmitted to the LED lighting system to display the string using the LED lighting system as part of an LED lighting animation.

### Mounting Implement for Musical Instrument Lighting and Animation

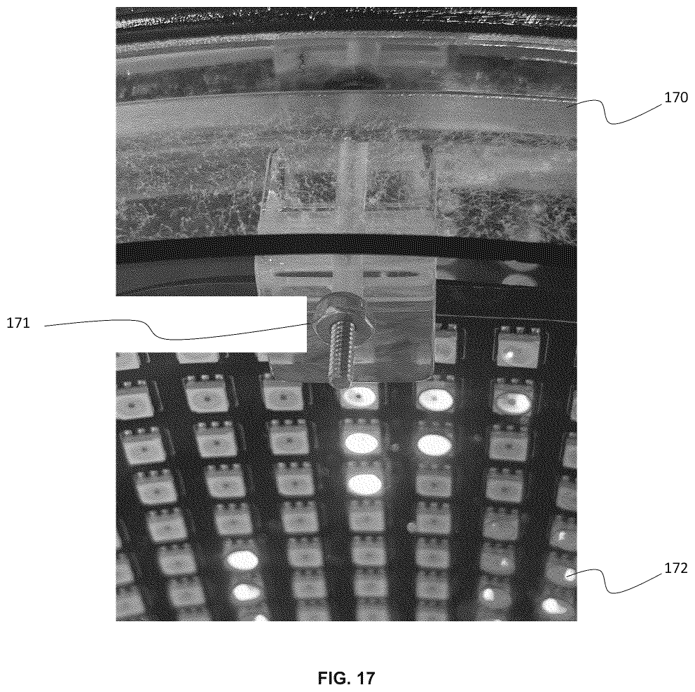

FIG. 17 depicts an exemplary musical instrument 170 including an LED lighting system 172 secured to musical instrument 170 using one or more standoffs 171 according to embodiments of the present invention. Standoffs 171 can secure components of the LED lighting system, such as LED panels, to the instrument, either within a cavity of the instrument, or on an outer surface of the instrument.

Standoffs 171 can be made of a clear acrylic material, plastic, or the like, to firmly hold lighting components in place and withstands the vibration and percussion produced by the instrument during use (e.g., vibrations produced by the user interacting with the instrument). The standoff 171 depicted in the example of FIG. 17 includes a bolt and a nut that can be tightened to securely press standoff 171 against LED lighting panel 172 to keep it in place during use. The bolt can be securely fastened to a surface or housing of the musical instrument 170, and the housing can be made of a substantially transparent material that allows the LED lighting to be visible from outside of the musical instrument 170. Moreover, the nut can be loosened to remove LED lighting panel 172 from musical instrument 170 for cleaning, repair, replacement, or the like.

According to some embodiments, the LED lighting panels are made of a flexible material, and the LED lighting panels are oriented to face the inside of the musical instrument, or can be oriented to project outward from an outer surface of the musical instrument, or both.

According to some embodiments, the LED lighting panels are at least partially covered by a diffuser and/or a diffraction grating to modify the appearance of the lighting produced by the LED lighting system of the musical instrument, and or to partially hide the electronic components used to fasten and drive the LED elements.

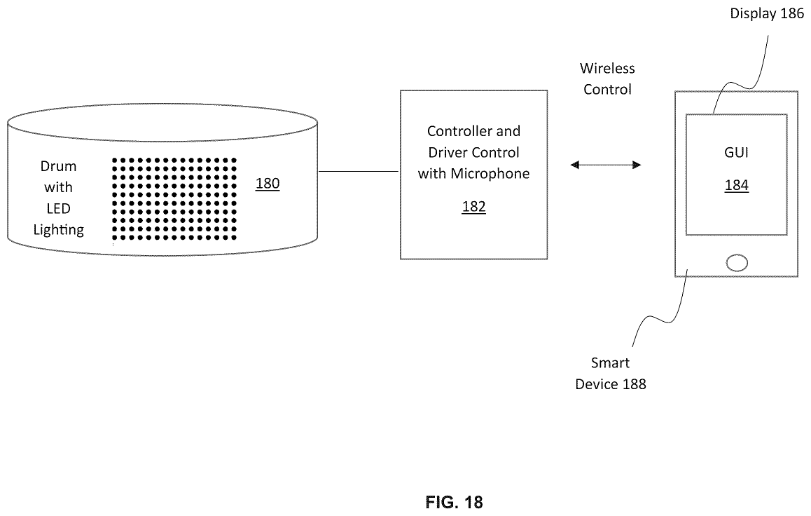

FIG. 18 depicts an exemplary computer-controlled lighting control system for generating animation sequences displayed on an LED lighting system of a musical instrument according to embodiments of the present invention. In the example of FIG. 18, a drum 180 including an LED lighting system is communicatively coupled to a controller and driver control system 182 with a microphone that detects sound levels. Controller 182 can selectively drive the LED lighting system of drum 180 according to commands received from smart device 188, which communicates wirelessly with controller 182. Wireless communication can be performed over Bluetooth, Wi-Fi, etc. On-screen GUI 184 is displayed on display device 186 and can receive touch or other graphical user interface input from a user to define new lighting configurations for controller 182 to produce lighting animations using the LED lighting system of drum 180, or can receive input from a keyboard, trackpad, mouse, etc.

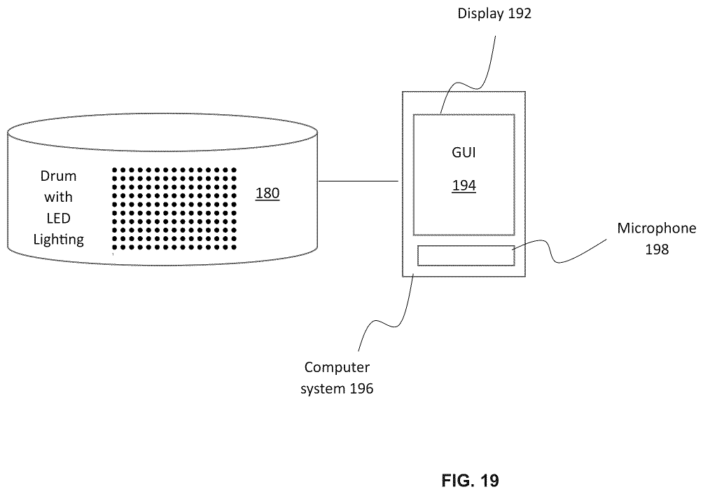

FIG. 19 depicts an exemplary computer-controlled lighting control system for generating animation sequences displayed on an LED lighting system of a musical instrument using a microphone of a computer system according to embodiments of the present invention. The example of FIG. 19 is similar to the example of FIG. 18, with a computer system 196 serving as both the controller and the configuration device. In this example, computer system 196 includes microphone 198 for detecting sound levels, and a display 192 that renders a GUI 194 that can be used to input new lighting configurations to drive the LED lighting system of drum 180.

Embodiments of the present invention are thus described. While the present invention has been described in particular embodiments, it should be appreciated that the present invention should not be construed as limited by such embodiments, but rather construed according to the following claims.

What is claimed is:

1. An apparatus for producing dynamic lighting for use in conjunction with a musical instrument, said apparatus comprising:
a housing;
a microphone operable to detect real-time sound levels produced by the musical instrument;
an LED interface and panel for controllably emitting light using a plurality of LEDs wherein each LED is discretely activated;
a mounting implement operable to secure the LED panel to the housing; and
a microcontroller operable to send control signals to the LED interface to cause the plurality of LEDs to emit light corresponding to lighting sequences, wherein the lighting sequences are dynamically adjusted responsive to the real-time sound levels produced by the musical instrument exceeding a predetermined threshold.

2. An apparatus as described in claim 1, wherein the plurality of LEDs is disposed within the musical instrument, and wherein the surface is substantially transparent.

3. An apparatus as described in claim 2, wherein the plurality of LEDs is disposed on a surface of the musical instrument.

4. An apparatus as described in claim 3, wherein the plurality of LEDs is secured to the surface of the musical instrument using a plurality of standoffs.

5. An apparatus as described in claim 1, further comprising a touch screen input device communicatively coupled to the microcontroller and operable to adjust a brightness level of the plurality of LEDs according to touch input received by the touch screen input device.

6. An apparatus as described in claim 1, further comprising a touch screen input device communicatively coupled to the microcontroller and operable to adjust an animation speed the lighting sequences according to touch input received by the touch screen input device.

7. An apparatus as described in claim 1, further comprising a touch screen input device communicatively coupled to the microcontroller and operable to adjust the threshold according to touch input received by the touch screen input device.

8. An apparatus as described in claim 1, further comprising a touch screen input device communicatively coupled to the microcontroller and operable to:
receive red, green, and blue color values according to touch input received by the touch screen input device; and store the red, green, and blue color values as a stored color, wherein the microcontroller is operable to cause the plurality of LEDs to emit light corresponding to the stored color.

9. A method of producing LED lighting responsive to sound produced by a musical instrument, said method comprising:
receiving control signals from an external touch screen device operable to render a graphical user interface;
sending the control signals to an LED interface to cause the LED interface to illuminate a plurality of LEDs, disposed in an array, using an LED animation sequence corresponding to the control signals;
measuring a sound level produced by a musical instrument in real-time using a microphone;
determining that the sound level of the musical instrument is above a sound level threshold; and
generating updated control signals for the LED interface, wherein the updated control signals dynamically adjust the LED animation sequence responsive to determining that the sound level is above the sound level threshold,
wherein the LED interface controls the plurality of LEDs to produce the LED animation sequence in accordance with said sound level produced by said musical instrument.

10. A method as described in claim 9, wherein the LED animation sequence comprises illuminating LEDs of the plurality of LEDs in a rainfall pattern.

11. A method as described in claim 10, wherein the updated control signals adjust the LED animation sequence by increasing an animation speed of the LED animation sequence.

12. A method as described in claim 11, wherein the receiving control signals from an external device comprises receiving red, green, and blue color values from a color mixer of the graphical user interface.

13. A method as described in claim 9, wherein the receiving control signals from an external device comprises receiving a brightness level from a slider of the graphical user interface.

14. A method as described in claim 9, wherein the receiving control signals from an external device comprises receiving a threshold level from a slider of the graphical user interface.

15. A method as described in claim 9, wherein the receiving control signals from an external device comprises receiving an animation speed of the LED animation sequence from a slider of the graphical user interface.

16. A method as described in claim 9, further comprising reviving a new animation sequence from the external device.

17. A musical instrument for generating animated LED lighting, the musical instrument comprising:
a housing;
an LED panel for emitting light using a plurality of LEDs;
a mounting implement coupled to the housing and operable to secure the LED panel to the housing, wherein the mounting implement comprises:
a base fixed to the housing operable to support the LED panel; and
a fastener operable to tighten the base against the LED panel.

18. The musical instrument of claim 17, wherein the housing is made from a substantially transparent material, wherein the musical instrument further comprises a cavity that is visible from outside of the musical instrument, and wherein the LED panel is disposed within the cavity and is operable to illuminate the cavity.

19. The musical instrument of claim 17, wherein the LED panel is disposed on an outer surface of the housing.
